(19) United States
(12) Patent Application Publication
(10) Pub. No.: US 2008/0286425 A1
(43) Pub. Date: Nov. 20, 2008

(54) Continuous Meat Marination Method and Apparatus

(76) Inventor: John Malcolm Lennox, III, Sebastopol, CA (US)

Correspondence Address: STAINBROOK & STAINBROOK, LLP, 412 AVIATION BOULEVARD, SUITE H, SANTA ROSA, CA, 95403, US

(21) Appl. No.: 11/814,510

(22) PCT Filed: Jan. 23, 2006
(86) PCT No.: PCT/US2006/002193

§ 371 Date: Apr. 7, 2008

Related U.S. Application Data
(60) Provisional application No. 60/645,948, filed on Jan. 22, 2005.

(51) Int. Cl. A23L 1/318; A22C 9/00

(52) U.S. Cl. 426/281; 452/141; 452/144; 426/650

(57) ABSTRACT

A machine for the continuous marination of meat products massages the meat pieces in marinade and the marinade in contact with the meat pieces at all times during the marinating process. The apparatus includes a rotating cylindrical drum made from a series of adjacent longitudinal, sawtooth-shaped internal vanes. The vanes are segmented by longitudinally spaced dividers forming compartments in the drum, with periodic transfer sections to urge the meat and marinade mixture from one compartment to the next as the drum is rotated. The drum may be rotated in one direction for approximately one revolution at a high RPM, and then stopped and rotated in the other direction.

### BACKGROUND OF THE INVENTION

1. Technical Field

The present invention relates generally to food processing and associated equipment, and more particularly to an improved method and apparatus for the continuous marination of meat.

2. Background Art

The marination of meat pieces has historically been accomplished in a closed drum under vacuum. The drum of a vacuum tumbler has vanes inside that aggressively agitate the meat pieces in contact with the marinade as the drum is rotated. The vacuum applied to the drum causes the air pockets in the meat to be partially replaced with marinade. With this type of system the absorption of marinade into the meat represents approximately 8 to 18% of the weight of the unmarinated meat pieces.

A typical vacuum marinator is described in Lennox, III, U.S. Pat. No. 5,104,232 for Vane and Chilling Systems for Tumble Mixers. That patent discloses an improved vacuum tumble mixer having a horizontal drum with a cylindrical mid-section, frusto-conical or dished entry and discharge ends, and entry and discharge openings axially into the ends, the drum being rotatable in one direction to tumble products therein and rotatable in the other direction to discharge the contents from the discharge opening. A plurality of primary vanes are secured helically to the interior of the mid-section of the drum, the primary vanes having radial tumbling surfaces to tumble the product and to move the product gently towards the entry end of the drum, the vanes having opposed channel-shaped discharge surfaces which progressively increase in height to convey the products in the drum to discharge chutes that extend helically along the discharge end of the drum to the discharge opening. A chilling system can be provided with one or more CO2 snowhorns positioned at one of the ends to discharge CO2 snow into the rotating drum for mixing with the products after vacuum tumbling. The CO2 snow is produced in repeated bursts with the on-and-off time of the repeated bursts being chosen to match the rate of production of CO2 snow to the rate such snow can be mixed with the product.

One disadvantage of this “batch” method of marination is that it requires substantial labor to load and unload the vacuum tumbler. Since most down stream process systems (e.g., ovens, fryers, breading and packaging equipment) are continuous, this marination batch system detracts from the efficiency of the processing line. Another disadvantage of a vacuum tumbler is that as the drum rotates the meat is elevated by the internal vanes in the vacuum drum draining the marinade away from the meat pieces. Since the meat is separated from the meat pieces at least part of the time during the marinating step, the absorption of the marinade is limited. An additional disadvantage is that it is very difficult to achieve a deep vacuum in the industrial plants. The maintenance costs of keeping the seals airtight on a vacuum tumbler are extremely high, and the seals are still prone to leakage, thus reducing the practical vacuum level that can be achieved. Lower vacuum levels translate into lower marinated meat yields.

Existing continuous-type marinating systems are either vacuum systems or excess marinade systems. Continuous vacuum marinating systems are very similar to batch vacuum tumblers with the same disadvantage of having the marinade drain away from the meat pieces as the drum rotates. Since the vacuum marinating drum rotates only in one direction, it must rotate very slowly to maintain the desired residence time under vacuum in the tumbler drum. The slow rotation exaggerates the separation time of the meat pieces and marinade and also imparts inadequate massaging energy into the meat to enable the marinade to be absorbed into the air pockets in the meat. In summary, continuous vacuum tumblers are inefficient marinators because the slow rotation does not massage the product aggressively enough and the marinade does not stay in contact with the meat continuously during the process.

Excess marinade systems provide a continuous system that does keep the marinade in contact with the meat pieces all of the time during the marinating process and also imparts aggressive energy into the meat pieces. The system has a rotating paddle agitator inside of the drum that rotates at a higher RPM than the drum itself. This system also keeps the marinade in contact with the meat pieces all the time since this system uses a high ratio of marinade to meat pieces, thus ‘bathing’ the meat pieces in marinade throughout the marinating process. Ratios as high as three parts marinade to one part meat are required to make this system function.

The disadvantage of this system is the high ratio of marinade to meat required to make this system work. The USDA resists this type of marinating system because the excess marinade must be recycled and re-used which can spread pathogen contamination. The processors resist this excess marinade system because of the complication of managing the re-cycling of marinade. The re-cycled marinade must be chilled continuously to hold down the temperature to minimize pathogen growth. Also the marinade must be continuously filtered to avoid a build up of blood and meat fines in the re-cycled marinade.

A continuous system that does not require excess marinade and at the same time imparts adequate massaging energy to the meat pieces would be a real step forward in marination technology. In addition, if the system keeps the meat and the marinade together continuously, it will enhance the marinade pickup potential of the system.

The foregoing discussion reflects the current state of the art of which the present inventor is aware. Reference to, and discussion of, this information is intended to aid in discharging Applicant's acknowledged duty of candor in disclosing information that may be relevant to the examination of claims to the present invention. However, it is respectfully submitted that none of the above-indicated information discloses, teaches, suggests, shows, or otherwise renders obvious, either singly or when considered in combination, the invention described and claimed herein.

### DISCLOSURE OF INVENTION

The continuous meat marination method and apparatus of this invention provides a machine for the continuous marination of meat products which involves the aggressive massaging of pre-conditioned meat pieces in marinade in a manner that also keeps the marinade in contact with the meat pieces at all times during the marinating process. The inventive apparatus includes a rotating cylindrical drum made from a series of adjacent longitudinal, sawtooth-shaped internal vanes designed to avoid separation of the marinade from the meat pieces as the drum rotates. The vanes are segmented by longitudinally spaced dividers forming compartments in the drum, with periodic transfer sections to urge the meat and marinade mixture from one compartment to the next as the drum is rotated, or one or more spiral dividers the length of the drum. To facilitate imparting adequate massaging energy to the meat the drum is rotated in one direction for approximately one revolution at a high RPM, and then the drum is stopped and rotated in the other direction (reversed). The vanes function equally well in either direction.

It is therefore an object of the present invention to provide a new and improved marinating apparatus for meat products.

It is another object of the present invention to provide a new and improved meat marinating apparatus that does not require a vacuum.

A further object or feature of the present invention is a new and improved continuous meat marinating machine that keeps the marinade in contact with the meat at all times.

An even further object of the present invention is to provide a novel method for continuous marination of meat products.

Other novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the Abstract is to enable the national and regional patent offices and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is an end elevation cross-sectional view of a continuous meat marination apparatus of this invention, illustrating a cylindrical drum made from a series of adjacent longitudinal, sawtooth-shaped internal vanes;

FIG. 2A is a perspective view of the cylindrical drum;

FIG. 2B is a cutaway view of the inside of the drum;

FIG. 3A is an end elevation view of the apparatus as mounted on a support structure, and illustrating a flat ring attached to the outside of the drum and rotated by drive wheels; and

FIG. 3B is a side elevation view illustrating the mounted apparatus with a pair of flat rings attached to the cylindrical drum, with associated drive wheels to rotate the flat rings and drum.

### BEST MODE FOR CARRYING OUT THE INVENTION

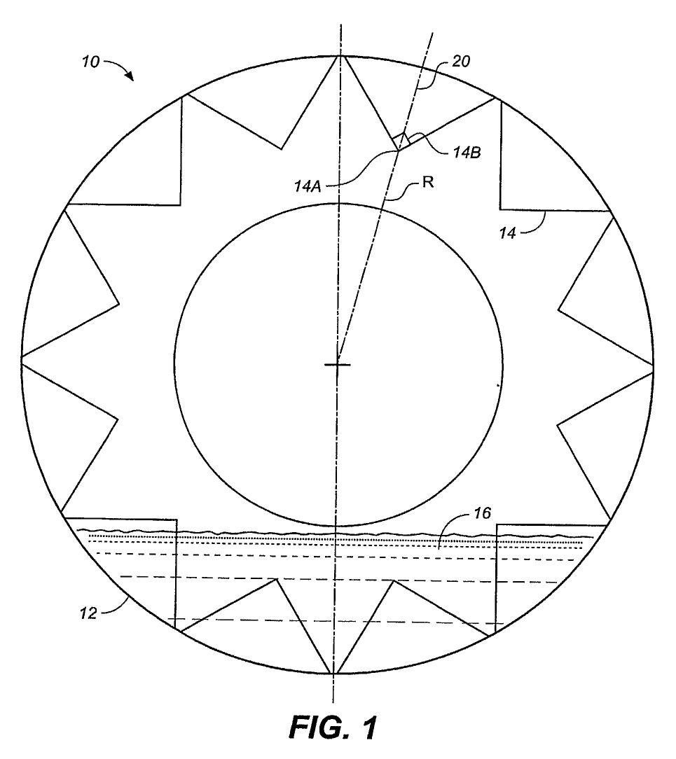

Referring to FIGS. 1 through 3B, wherein like reference numerals refer to like components in the various views, there is illustrated therein a new and improved continuous meat marination apparatus, generally denominated 10 herein. The apparatus provides a continuous non-vacuum marinating drum which does not require excess marinade to keep the marinade in contact with the meat at all times during the marinating process. The drum consists of a cylinder formed from a series of adjacent, longitudinal saw tooth shaped vanes. The combination of vane height, vane shape and vane speed (drum rotational speed) determines the effectiveness of the marinating system.

FIG. 1 is an end elevation cross-sectional view of continuous meat marination apparatus 10 of this invention, illustrating a cylindrical drum 12 made from a series of longitudinal, sawtooth-shaped internal vanes 14. The main design characteristics of this system are as follows. The saw tooth shape vanes 14 preferably have the same angle on each side of the vane (the leading edge and following edge), i.e., the vane is symmetrical about the radius R through the apex 14a of the vane. In one application, it has been determined that in order to keep the marinade in contact with the meat at all times during the rotation of the drum, the internal angle 14b of the vane should be approximately 90 degrees, i.e., the leading edge and following edge form an approximate right angle. As the drum rotates each vane lifts the marinade and meat pieces upward. The angle of the saw tooth vane causes the marinade to cascade off of the vane ‘washing’ the meat off the vane with it. The meat pieces are not separated from the marinade as the vane moves upward during the rotation of the drum. As the meat and marinade flow off of each vane they fall back into the pool 16 of product and marinade and onto the next vane, imparting an aggressive agitation to the meat and marinade.

The height 20 of the saw tooth vanes 14 is designed to maximize the energy imparted to the meat and marinade as the drum rotates. The meat and marinade flowing over one vane down into the pool 16 of product and marinade in the ‘valley’ between vanes agitates the meat and marinade together.

The optimum height of the vanes may vary as a percentage of the drum diameter. For example, it has been determined that the vane height may be between approximately 10% and 15% of the outside diameter of the drum. The number of vanes is determined by positioning the base of each vane to the base of the adjacent vanes.

The height of the saw tooth vanes 14 should be limited to allow sufficient volume in each chamber to handle the volume of product and marinade required to meet the design throughput requirements of the tumbler drum. The minimum height of the vanes is also limited by the requirements of the number of vanes and the height necessary to provide the agitation requirements. The larger the diameter of the drum the higher the vanes can be and still maximize the number of ‘tumbles’ the meat and marinade sees during one revolution. The number of ‘tumbles’ in a full residence time in the tumbler should be enough to facilitate the absorption of marinade desired. However, the speed the vanes as they move through the product should also be high enough to provide the desired marinade absorption.

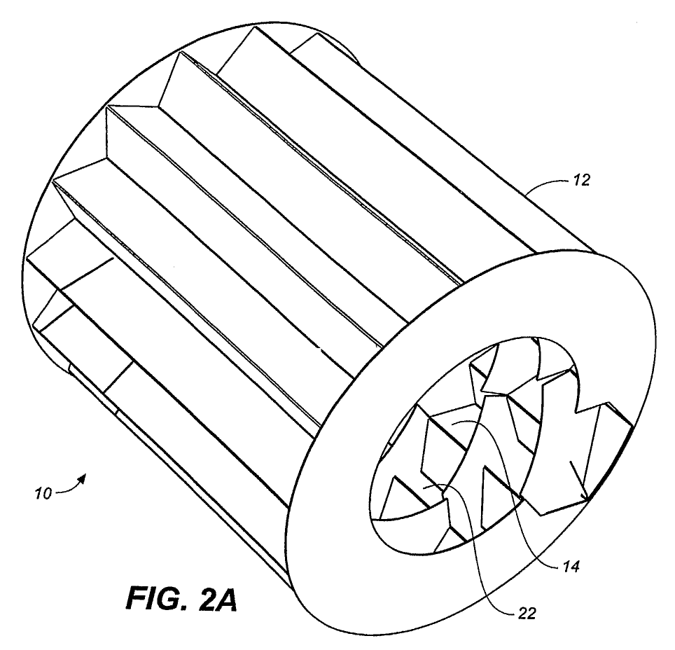

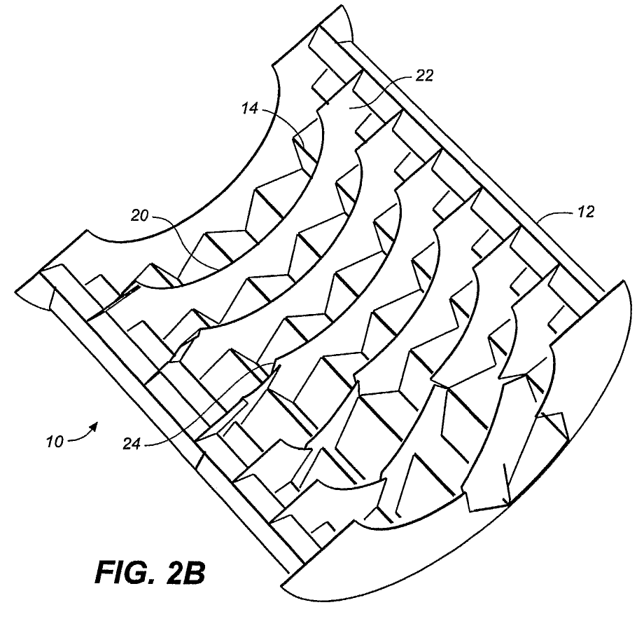

FIG. 2A is a perspective view of the cylindrical drum 12, while FIG. 2B is a cutaway view of the inside of the drum 12. The drum is divided in its length by longitudinally spaced metal dividers 20 which form compartments 22 which control the product as it progresses through the drum as the drum rotates. At approximately the 330 degree point in each divided compartment is a transfer chute 24 which pushes the product from one divided compartment to the next as the drum rotates. Alternatively, the divider feature may take the form of one or more spiral dividers the length of the drum, thereby creating adjacent, longitudinal “compartments.” These would serve to move the meat and marinade through the drum as it is rotated.

The drum should be relatively short so that the vanes and compartments can be visually inspected from one end or the other. For example, USDA inspectors will not climb into the drum to inspect for cleanliness. Instead, they must be able to see into the drum from each end.

In order to keep the length of the drum short resulting in fewer vanes in the drum, the drum is preferably rotated in one direction for approximately one revolution, and then in the reverse direction for something less than a full revolution. This operation for more time in the forward direction than in the reverse direction allows holding a higher RPM for a preset dwell time. This reversing operation also results in maximizing the number of tumbles over vanes that the meat pieces see during this preset dwell time.

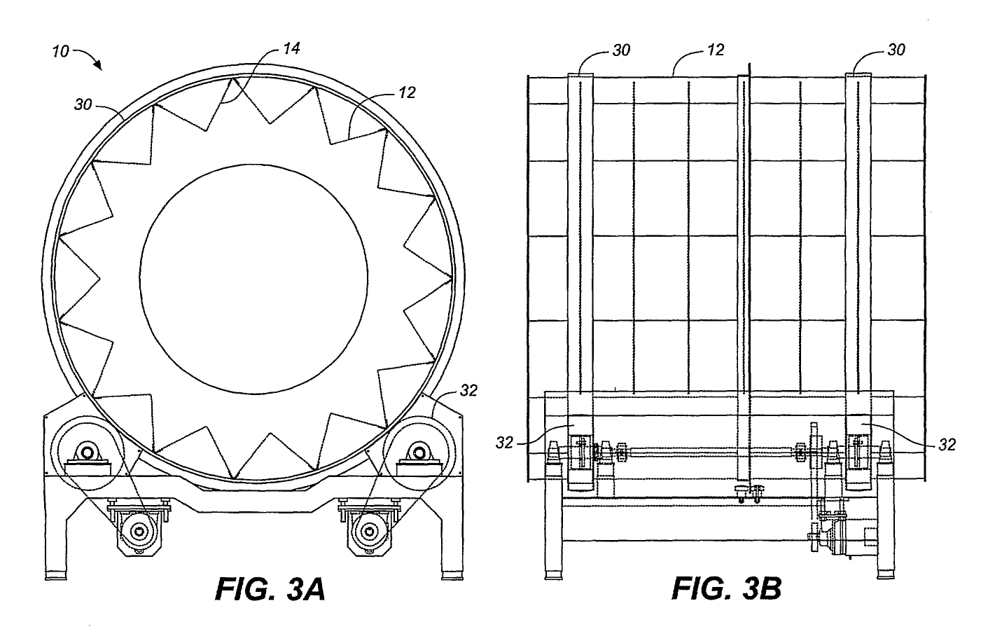

FIG. 3A is an end elevation view of the apparatus illustrating a flat ring 30 mounted to the outside of the drum 12 and rotated by drive wheels 32, while FIG. 3B is a side elevation view illustrating the a pair of flat rings 30 mounted on the cylindrical drum 12, with associated drive wheels 32 to rotate the flat rings and drum. The drum is preferably driven by four rubber drive wheels 32 driving the flat rings 30 which are welded to the outside of each saw toothed vane 14. This method of driving the drum avoids having the traction of the drive system against the drum affected by the cold temperature of the meat pieces or the marinade. The flat rings 30 are attached so that they have little contact with the drum, thus the temperature of the product is not transferred into the flat rings or drive assembly.

As described above, the drum drive system is preferably operated in the forward direction for a preset period of time for close to one full revolution and in the reverse direction for a time less than the time forward. This action is to allow an increase in the RPM while maintaining a predetermined total number of revolutions forwards. One disadvantage of this design is that all the product in one compartment is discharged from the drum at the same time. This creates very uneven discharge which complicates smoothing out the feeding of the product onto the down stream conveyors which must be continuous and uniform. One solution would be to control the drum rotation so that it always stops and reverses the forward rotation at the precise point where about half of the product in a compartment is discharged and the rest is discharged on the next forward revolution. This is accomplished by installing a reversing sensor on the drum. In this case the variables that control the drum would be reverse time and RPM, but the forward rotation would be a varying portion of one revolution.

The drum being preferably formed entirely by the saw tooth shape of the vanes assures that there are no welds in the saw tooth outer wall of the drum to crack and leak marinade. Even if the saw tooth wall of the drum cracks, the leaked marinade is easily seen from the outside of the drum. There is no risk for hidden areas for marinade or meat juice to collect and decay.

Accordingly, the continuous meat marination apparatus of this invention may be characterized as a continuous meat marination apparatus for marinating meat pieces in a marinade, including a cylindrical drum having a longitudinal axis and comprising a series of adjacent longitudinal, sawtooth-shaped internal vanes; at least one longitudinally spaced divider dividing the vanes to form compartments in the drum; and at least one transfer section in the longitudinally spaced divider to urge the meat and marinade mixture from one compartment to a second compartment as the drum is rotated about its longitudinal axis.

The continuous meat marination method of this invention may be characterized as a method for continuous marinating of meat pieces in a marinade comprising the steps of: providing a cylindrical drum having a longitudinal axis and comprising a series of adjacent longitudinal, sawtooth-shaped internal vanes; providing at least one longitudinally spaced divider dividing the vanes to form compartments in the drum; providing at least one transfer section in the divider; and rotating the drum about the longitudinal axis to urge the meat and marinade mixture from one compartment to a second compartment.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A continuous meat marination apparatus for marinating meat pieces in a marinade, said apparatus comprising:
a cylindrical drum having a longitudinal axis and comprising a series of adjacent longitudinal, sawtooth-shaped internal vanes;
at least one divider dividing said vanes to form compartments in said drum; and
means to move the meat pieces and marinade through said drum.

2. The continuous meat marination apparatus of claim 1 wherein said at least one divider comprises at least one longitudinally spaced divider dividing said vanes to form compartments in said drum, and further including at least one transfer section in said at least one longitudinally spaced divider to urge the meat and marinade mixture from one compartment to a second compartment as said drum is rotated about said longitudinal axis.

3. The continuous meat marination apparatus of claim 1 wherein said sawtooth-shaped vanes are symmetrical about a radius through the apex of said vanes.

4. The continuous meat marination apparatus of claim 1 wherein said sawtooth-shaped vanes have a leading edge and a trailing edge, and said leading edge and following edge form an approximate right angle.

5. The continuous meat marination apparatus of claim 1 wherein said drum has an outside diameter, and said sawtooth-shaped vanes have a height between approximately 10% and 15% of said outside diameter.

6. The continuous meat marination apparatus of claim 2 wherein said at least one transfer section in said at least one longitudinally spaced divider is positioned at approximately 330 degrees in said compartment.

7. The continuous meat marination apparatus of claim 1 wherein said drum includes at least one flat ring mounted to the outside of said drum.

8. The continuous meat marination apparatus of claim 1 wherein said at least one flat ring mounted to the outside of said drum is rotated by a drive wheel.

9. The continuous meat marination apparatus of claim 8 wherein including two flat rings mounted to the outside of said drum rotated by four drive wheels.

10. A method for continuous marinating of meat pieces in a marinade, said method comprising the steps of:
providing a cylindrical drum having a longitudinal axis and comprising a series of adjacent longitudinal, sawtooth-shaped internal vanes;
providing at least one longitudinally spaced divider dividing the vanes to form compartments in the drum;
providing at least one transfer section in the divider; and
rotating the drum about the longitudinal axis to urge the meat and marinade mixture from one compartment to a second compartment.

11. The method for continuous marinating of meat pieces in a marinade of claim 10 further including the step of:
rotating the drum in one direction for approximately one revolution, then rotating the drum in the reverse direction for something less than a full revolution.

12. The method for continuous marinating of meat pieces in a marinade of claim 10 further including the step of:
rotating the drum to lift the marinade and meat pieces upward until the angle of the saw tooth vane causes the marinade and meat pieces to cascade off of the vane.

13. The method for continuous marinating of meat pieces in a marinade of claim 10 further including the step of:
providing a pool of meat pieces and marinade in the drum.

14. The method for continuous marinating of meat pieces in a marinade of claim 10 further including the step of:
rotating the drum in one direction for a first period of time, then rotating the drum in the reverse direction for shorter period of time.

15. The method for continuous marinating of meat pieces in a marinade of claim 10 further including the step of:
rotating the drum for a preset dwell time.

16. The method for continuous marinating of meat pieces in a marinade of claim 10 further including the step of:
rotating the drum on a flat ring mounted to the outside of the drum.

17. The method for continuous marinating of meat pieces in a marinade of claim 16 further including the step of:
rotating the flat ring mounted to the outside of the drum with a drive wheel.
